(19) United States
(12) Patent Application Publication
(10) Pub. No.: US 2017/0293654 A1
(43) Pub. Date: Oct. 12, 2017

(54) DEFERRED JOINING OF A STREAM OF TUPLES

(71) Applicant: International Business Machines Corporation, Armonk, NY (US)

(72) Inventors: Bin Cao, Rochester, MN (US); Jessica R. Eidem, Rochester, MN (US); Brian R. Muras, Otsego, MN (US); Jingdong Sun, Rochester, MN (US)

(21) Appl. No.: 15/097,276

(22) Filed: Apr. 12, 2016

(51) Int. Cl. G06F 17/30

(52) U.S. Cl. CPC G06F 17/30454; G06F 17/30516; G06F 17/30498

(57) ABSTRACT

Disclosed aspects relate to deferred joining of a stream of tuples. The stream of tuples which is to be processed by a plurality of stream operators is received. The stream of tuples may include both a first set of tuples from a first source and a second set of tuples from a second source. For future utilization with respect to a join operation which indicates to join the first and second sets of tuples, a determination is made to establish a group of tuples. A first stream operator of the plurality of stream operators establishes the group of tuples. The group of tuples has both a first subgroup and a second subgroup. A set of stream operators of the plurality of stream operators processes the group of tuples. In response to processing the group of tuples, the join operation is performed.

### BACKGROUND

This disclosure relates generally to computer systems and, more particularly, relates to deferred joining of a stream of tuples. The amount of data that needs to be managed by enterprises is increasing. A stream computing environment may be desired to be managed as efficiently as possible. As data needing to be managed increases, the need for management efficiency may increase.

### SUMMARY

Aspects of the disclosure relate to an intelligent deferred joining of groups or subgroups of tuples. The actual joining of individual tuples may be deferred by managing the runtime stream for processing groups or subgroups of tuples as appropriate. Aspects can join window groups and defer the actual join of individual tuples. Accordingly, processing operations after a determination to join but before the actual join operation can provide performance or efficiency benefits in terms of computing resource usage by having a positive impact on the total number of operations by operators.

Aspects of the disclosure relate to deferred joining of a stream of tuples. The stream of tuples which is to be processed by a plurality of stream operators is received. The stream of tuples may include both a first set of tuples from a first source and a second set of tuples from a second source. For future utilization with respect to a join operation which indicates to join the first and second sets of tuples, a determination is made to establish a group of tuples. A first stream operator of the plurality of stream operators establishes the group of tuples. The group of tuples has both a first subgroup and a second subgroup. A set of stream operators of the plurality of stream operators processes the group of tuples. In response to processing the group of tuples, the join operation is performed.

The above summary is not intended to describe each illustrated embodiment or every implementation of the present disclosure.

### BRIEF DESCRIPTION OF THE SEVERAL VIEWS OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 illustrates an exemplary computing infrastructure to execute a stream computing application according to embodiments.

FIG. 2 illustrates a view of a compute node according to embodiments.

FIG. 3 illustrates a view of a management system according to embodiments.

FIG. 4 illustrates a view of a compiler system according to embodiments.

FIG. 5 illustrates an exemplary operator graph for a stream computing application according to embodiments.

FIG. 6 is a flowchart illustrating a method for deferred joining of a stream of tuples according to embodiments.

FIG. 7 is an example operator graph of a deferred join when joining a set of windows according to embodiments.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION

Aspects of the disclosure relate to an intelligent deferred joining of groups or subgroups of tuples. The actual joining of individual tuples may be deferred by managing the runtime stream for processing groups or subgroups of tuples as appropriate. Aspects can join window groups and defer/delay (temporarily or permanently) the actual join of individual tuples. Accordingly, processing operations after a determination to join but before the actual join operation can provide performance or efficiency benefits in terms of computing resource usage by having a positive impact on the total number of operations by operators.

Stream-based computing and stream-based database computing are emerging as a developing technology for database systems. Products are available which allow users to create applications that process and query streaming data before it reaches a database file. With this emerging technology, users can specify processing logic to apply to inbound data records while they are “in flight,” with the results available in a very short amount of time, often in fractions of a second. Constructing an application using this type of processing has opened up a new programming paradigm that will allow for development of a broad variety of innovative applications, systems, and processes, as well as present new challenges for application programmers and database developers.

In a stream computing application, stream operators are connected to one another such that data flows from one stream operator to the next (e.g., over a TCP/IP socket). When a stream operator receives data, it may perform operations, such as analysis logic, which may change the tuple by adding or subtracting attributes, or updating the values of existing attributes within the tuple. When the analysis logic is complete, a new tuple is then sent to the next stream operator. Scalability is achieved by distributing an application across nodes by creating executables (i.e., processing elements), as well as replicating processing elements on multiple nodes and load balancing among them. Stream operators in a stream computing application can be fused together to form a processing element that is executable. Doing so allows processing elements to share a common process space, resulting in much faster communication between stream operators than is available using inter-process communication techniques (e.g., using a TCP/IP socket). Further, processing elements can be inserted or removed dynamically from an operator graph representing the flow of data through the stream computing application. A particular stream operator may not reside within the same operating system process as other stream operators. In addition, stream operators in the same operator graph may be hosted on different nodes, e.g., on different compute nodes or on different cores of a compute node.

Data flows from one stream operator to another in the form of a “tuple.” A tuple is a sequence of one or more attributes associated with an entity. Attributes may be any of a variety of different types, e.g., integer, float, Boolean, string, etc. The attributes may be ordered. In addition to attributes associated with an entity, a tuple may include metadata, i.e., data about the tuple. A tuple may be extended by adding one or more additional attributes or metadata to it. As used herein, “stream” or “data stream” refers to a sequence of tuples. Generally, a stream may be considered a pseudo-infinite sequence of tuples.

Tuples are received and output by stream operators and processing elements. An input tuple corresponding with a particular entity that is received by a stream operator or processing element, however, is generally not considered to be the same tuple that is output by the stream operator or processing element, even if the output tuple corresponds with the same entity or data as the input tuple. An output tuple need not be changed in some way from the input tuple.

Nonetheless, an output tuple may be changed in some way by a stream operator or processing element. An attribute or metadata may be added, deleted, or modified. For example, a tuple will often have two or more attributes. A stream operator or processing element may receive the tuple having multiple attributes and output a tuple corresponding with the input tuple. The stream operator or processing element may only change one of the attributes so that all of the attributes of the output tuple except one are the same as the attributes of the input tuple.

Generally, a particular tuple output by a stream operator or processing element may not be considered to be the same tuple as a corresponding input tuple even if the input tuple is not changed by the processing element. However, to simplify the present description and the claims, an output tuple that has the same data attributes or is associated with the same entity as a corresponding input tuple will be referred to herein as the same tuple unless the context or an express statement indicates otherwise.

Stream computing applications handle massive volumes of data that need to be processed efficiently and in real time. For example, a stream computing application may continuously ingest and analyze hundreds of thousands of messages per second and up to petabytes of data per day. Accordingly, each stream operator in a stream computing application may be required to process a received tuple within fractions of a second. Unless the stream operators are located in the same processing element, it is necessary to use an inter-process communication path each time a tuple is sent from one stream operator to another. Inter-process communication paths can be a critical resource in a stream computing application. According to various embodiments, the available bandwidth on one or more inter-process communication paths may be conserved. Efficient use of inter-process communication bandwidth can speed up processing.

A streams processing job has a directed graph of processing elements that send data tuples between the processing elements. The processing element operates on the incoming tuples, and produces output tuples. A processing element has an independent processing unit and runs on a host. The streams platform can be made up of a collection of hosts that are eligible for processing elements to be placed upon. When a job is submitted to the streams run-time, the platform scheduler processes the placement constraints on the processing elements, and then determines (the best) one of these candidates host for (all) the processing elements in that job, and schedules them for execution on the decided host.

Aspects of the disclosure include a method, system, and computer program product for deferred joining of a stream of tuples. The stream of tuples which is to be processed by a plurality of stream operators is received. The stream of tuples may include both a first set of tuples from a first source and a second set of tuples from a second source. For future utilization with respect to a join operation which indicates to join the first and second sets of tuples, a determination is made to establish a group of tuples. A first stream operator of the plurality of stream operators establishes the group of tuples. The group of tuples has both a first subgroup and a second subgroup. A set of stream operators of the plurality of stream operators processes the group of tuples. In response to processing the group of tuples, the join operation is performed. Altogether, performance or efficiency benefits with respect to stream application development or stream computing can occur (e.g., speed, flexibility, ease of development, resource usage, productivity). Aspects may save resources such as bandwidth, processing, or memory.

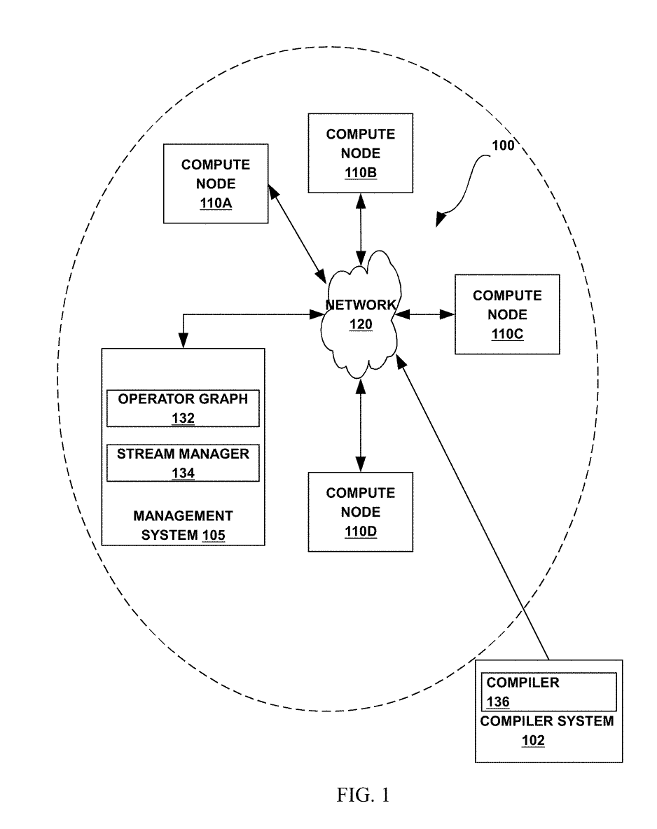

FIG. 1 illustrates one exemplary computing infrastructure 100 that may be configured to execute a stream computing application, according to some embodiments. The computing infrastructure 100 includes a management system 105 (which can include an operator graph 132 and a stream manager 134) and two or more compute nodes 110A-110D—i.e., hosts—which are communicatively coupled to each other using one or more communications networks 120. The communications network 120 may include one or more servers, networks, or databases, and may use a particular communication protocol to transfer data between the compute nodes 110A-110D. A compiler system 102 may be communicatively coupled with the management system 105 and the compute nodes 110 either directly or via the communications network 120.

The communications network 120 may include a variety of types of physical communication channels or “links.” The links may be wired, wireless, optical, or any other suitable media. In addition, the communications network 120 may include a variety of network hardware and software for performing routing, switching, and other functions, such as routers, switches, or bridges. The communications network 120 may be dedicated for use by a stream computing application or shared with other applications and users. The communications network 120 may be any size. For example, the communications network 120 may include a single local area network or a wide area network spanning a large geographical area, such as the Internet. The links may provide different levels of bandwidth or capacity to transfer data at a particular rate. The bandwidth that a particular link provides may vary depending on a variety of factors, including the type of communication media and whether particular network hardware or software is functioning correctly or at full capacity. In addition, the bandwidth that a particular link provides to a stream computing application may vary if the link is shared with other applications and users. The available bandwidth may vary depending on the load placed on the link by the other applications and users. The bandwidth that a particular link provides may also vary depending on a temporal factor, such as time of day, day of week, day of month, or season.

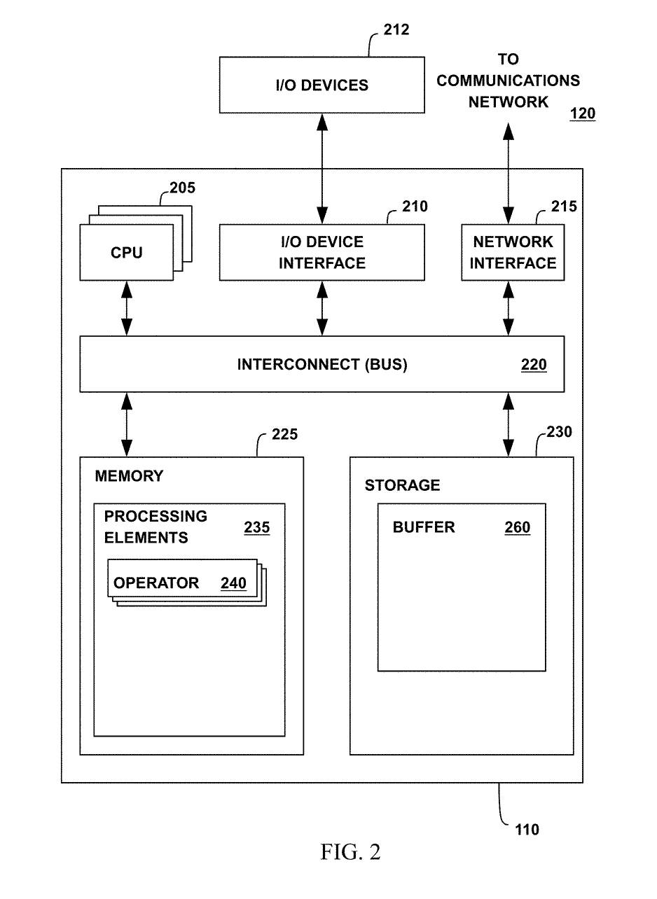

FIG. 2 is a more detailed view of a compute node 110, which may be the same as one of the compute nodes 110A-110D of FIG. 1, according to various embodiments. The compute node 110 may include, without limitation, one or more processors (CPUs) 205, a network interface 215, an interconnect 220, a memory 225, and a storage 230. The compute node 110 may also include an I/O device interface 210 used to connect I/O devices 212, e.g., keyboard, display, and mouse devices, to the compute node 110.

Each CPU 205 retrieves and executes programming instructions stored in the memory 225 or storage 230. Similarly, the CPU 205 stores and retrieves application data residing in the memory 225. The interconnect 220 is used to transmit programming instructions and application data between each CPU 205, I/O device interface 210, storage 230, network interface 215, and memory 225. The interconnect 220 may be one or more busses. The CPUs 205 may be a single CPU, multiple CPUs, or a single CPU having multiple processing cores in various embodiments. In one embodiment, a processor 205 may be a digital signal processor (DSP). One or more processing elements 235 (described below) may be stored in the memory 225. A processing element 235 may include one or more stream operators 240 (described below). In one embodiment, a processing element 235 is assigned to be executed by only one CPU 205, although in other embodiments the stream operators 240 of a processing element 235 may include one or more threads that are executed on two or more CPUs 205. The memory 225 is generally included to be representative of a random access memory, e.g., Static Random Access Memory (SRAM), Dynamic Random Access Memory (DRAM), or Flash. The storage 230 is generally included to be representative of a non-volatile memory, such as a hard disk drive, solid state device (SSD), or removable memory cards, optical storage, flash memory devices, network attached storage (NAS), or connections to storage area network (SAN) devices, or other devices that may store non-volatile data. The network interface 215 is configured to transmit data via the communications network 120.

A stream computing application may include one or more stream operators 240 that may be compiled into a “processing element” container 235. The memory 225 may include two or more processing elements 235, each processing element having one or more stream operators 240. Each stream operator 240 may include a portion of code that processes tuples flowing into a processing element and outputs tuples to other stream operators 240 in the same processing element, in other processing elements, or in both the same and other processing elements in a stream computing application. Processing elements 235 may pass tuples to other processing elements that are on the same compute node 110 or on other compute nodes that are accessible via communications network 120. For example, a processing element 235 on compute node 110A may output tuples to a processing element 235 on compute node 110B.

The storage 230 may include a buffer 260. Although shown as being in storage, the buffer 260 may be located in the memory 225 of the compute node 110 or in a combination of both memories. Moreover, storage 230 may include storage space that is external to the compute node 110, such as in a cloud.

The compute node 110 may include one or more operating systems 262. An operating system 262 may be stored partially in memory 225 and partially in storage 230. Alternatively, an operating system may be stored entirely in memory 225 or entirely in storage 230. The operating system provides an interface between various hardware resources, including the CPU 205, and processing elements and other components of the stream computing application. In addition, an operating system provides common services for application programs, such as providing a time function.

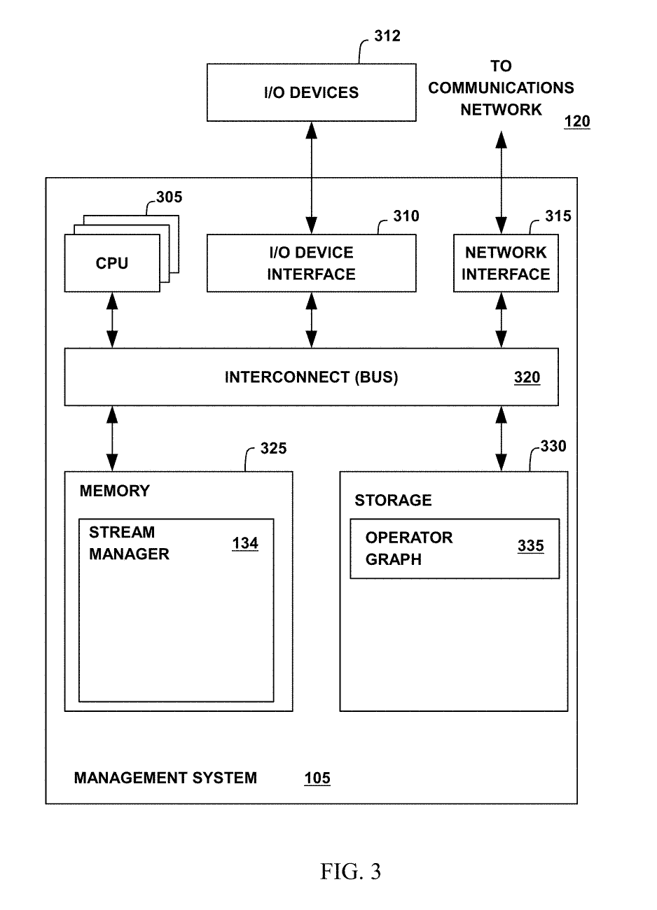

FIG. 3 is a more detailed view of the management system 105 of FIG. 1 according to some embodiments. The management system 105 may include, without limitation, one or more processors (CPUs) 305, a network interface 315, an interconnect 320, a memory 325, and a storage 330. The management system 105 may also include an I/O device interface 310 connecting I/O devices 312, e.g., keyboard, display, and mouse devices, to the management system 105.

Each CPU 305 retrieves and executes programming instructions stored in the memory 325 or storage 330. Similarly, each CPU 305 stores and retrieves application data residing in the memory 325 or storage 330. The interconnect 320 is used to move data, such as programming instructions and application data, between the CPU 305, I/O device interface 310, storage unit 330, network interface 315, and memory 325. The interconnect 320 may be one or more busses. The CPUs 305 may be a single CPU, multiple CPUs, or a single CPU having multiple processing cores in various embodiments. In one embodiment, a processor 305 may be a DSP. Memory 325 is generally included to be representative of a random access memory, e.g., SRAM, DRAM, or Flash. The storage 330 is generally included to be representative of a non-volatile memory, such as a hard disk drive, solid state device (SSD), removable memory cards, optical storage, Flash memory devices, network attached storage (NAS), connections to storage area-network (SAN) devices, or the cloud. The network interface 315 is configured to transmit data via the communications network 120.

The memory 325 may store a stream manager 134. Additionally, the storage 330 may store an operator graph 335. The operator graph 335 may define how tuples are routed to processing elements 235 (FIG. 2) for processing or stored in memory 325 (e.g., completely in embodiments, partially in embodiments).

The management system 105 may include one or more operating systems 332. An operating system 332 may be stored partially in memory 325 and partially in storage 330. Alternatively, an operating system may be stored entirely in memory 325 or entirely in storage 330. The operating system provides an interface between various hardware resources, including the CPU 305, and processing elements and other components of the stream computing application. In addition, an operating system provides common services for application programs, such as providing a time function. Portions of stream manager 134 or operator graph 335 may be stored in memory 325 or storage 330 at different times in various embodiments.

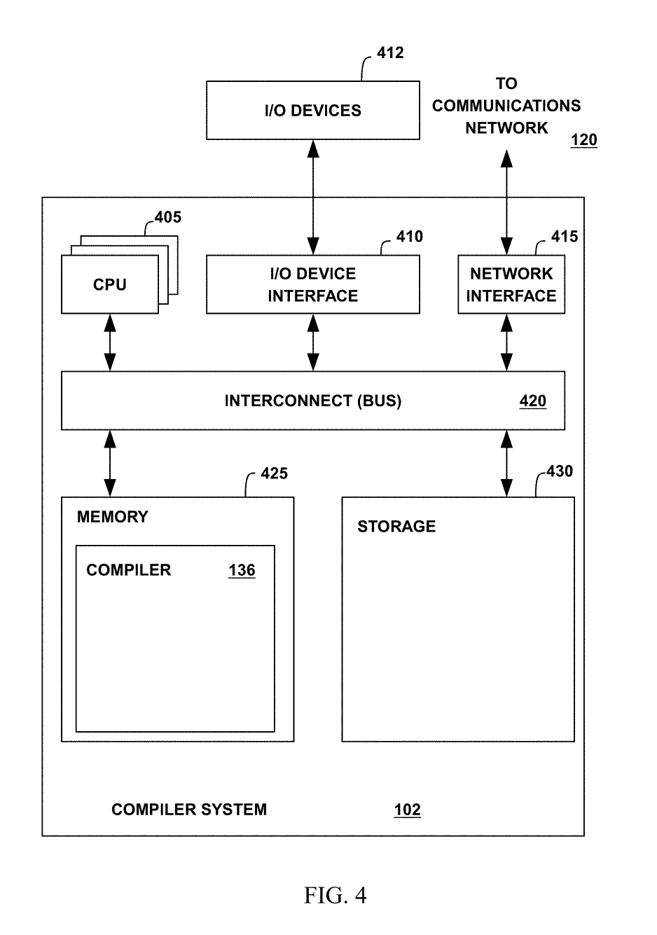

FIG. 4 is a more detailed view of the compiler system 102 of FIG. 1 according to some embodiments. The compiler system 102 may include, without limitation, one or more processors (CPUs) 405, a network interface 415, an interconnect 420, a memory 425, and storage 430. The compiler system 102 may also include an I/O device interface 410 connecting I/O devices 412, e.g., keyboard, display, and mouse devices, to the compiler system 102.

Each CPU 405 retrieves and executes programming instructions stored in the memory 425 or storage 430. Similarly, each CPU 405 stores and retrieves application data residing in the memory 425 or storage 430. The interconnect 420 is used to move data, such as programming instructions and application data, between the CPU 405, I/O device interface 410, storage unit 430, network interface 415, and memory 425. The interconnect 420 may be one or more busses. The CPUs 405 may be a single CPU, multiple CPUs, or a single CPU having multiple processing cores in various embodiments. In one embodiment, a processor 405 may be a DSP. Memory 425 is generally included to be representative of a random access memory, e.g., SRAM, DRAM, or Flash. The storage 430 is generally included to be representative of a non-volatile memory, such as a hard disk drive, solid state device (SSD), removable memory cards, optical storage, flash memory devices, network attached storage (NAS), connections to storage area-network (SAN) devices, or to the cloud. The network interface 415 is configured to transmit data via the communications network 120.

The compiler system 102 may include one or more operating systems 432. An operating system 432 may be stored partially in memory 425 and partially in storage 430. Alternatively, an operating system may be stored entirely in memory 425 or entirely in storage 430. The operating system provides an interface between various hardware resources, including the CPU 405, and processing elements and other components of the stream computing application. In addition, an operating system provides common services for application programs, such as providing a time function.

The memory 425 may store a compiler 136. The compiler 136 compiles modules, which include source code or statements, into the object code, which includes machine instructions that execute on a processor. In one embodiment, the compiler 136 may translate the modules into an intermediate form before translating the intermediate form into object code. The compiler 136 may output a set of deployable artifacts that may include a set of processing elements and an application description language file (ADL file), which is a configuration file that describes the stream computing application. In some embodiments, the compiler 136 may be a just-in-time compiler that executes as part of an interpreter. In other embodiments, the compiler 136 may be an optimizing compiler. In various embodiments, the compiler 136 may perform peephole optimizations, local optimizations, loop optimizations, inter-procedural or whole-program optimizations, machine code optimizations, or any other optimizations that reduce the amount of time required to execute the object code, to reduce the amount of memory required to execute the object code, or both. The output of the compiler 136 may be represented by an operator graph, e.g., the operator graph 335.

The compiler 136 may also provide the application administrator with the ability to optimize performance through profile-driven fusion optimization. Fusing operators may improve performance by reducing the number of calls to a transport. While fusing stream operators may provide faster communication between operators than is available using inter-process communication techniques, any decision to fuse operators requires balancing the benefits of distributing processing across multiple compute nodes with the benefit of faster inter-operator communications. The compiler 136 may automate the fusion process to determine how to best fuse the operators to be hosted by one or more processing elements, while respecting user-specified constraints. This may be a two-step process, including compiling the application in a profiling mode and running the application, then re-compiling and using the optimizer during this subsequent compilation. The end result may, however, be a compiler-supplied deployable application with an optimized application configuration.

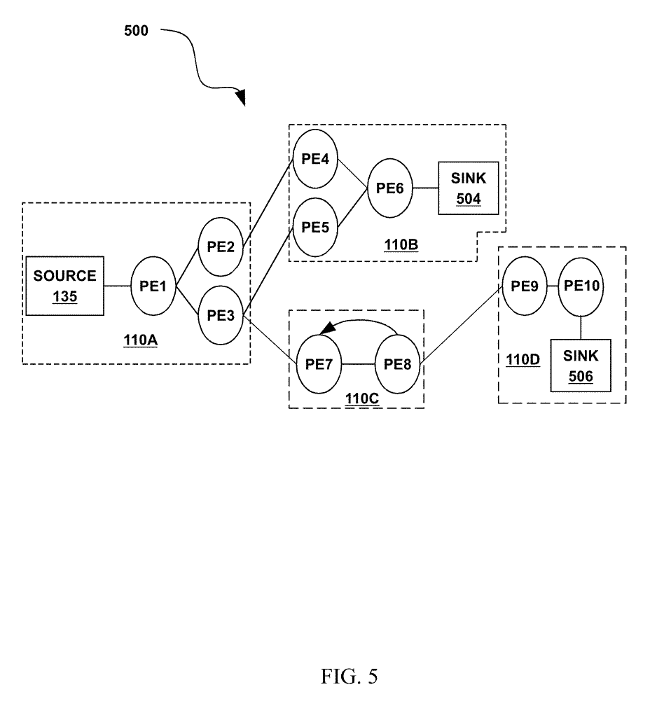

FIG. 5 illustrates an exemplary operator graph 500 for a stream computing application beginning from one or more sources 135 through to one or more sinks 504, 506, according to some embodiments. This flow from source to sink may also be generally referred to herein as an execution path. In addition, a flow from one processing element to another may be referred to as an execution path in various contexts. Although FIG. 5 is abstracted to show connected processing elements PE1-PE10, the operator graph 500 may include data flows between stream operators 240 (FIG. 2) within the same or different processing elements. Typically, processing elements, such as processing element 235 (FIG. 2), receive tuples from the stream as well as output tuples into the stream (except for a sink—where the stream terminates, or a source—where the stream begins). While the operator graph 500 includes a relatively small number of components, an operator graph may be much more complex and may include many individual operator graphs that may be statically or dynamically linked together.

The example operator graph shown in FIG. 5 includes ten processing elements (labeled as PE1-PE10) running on the compute nodes 110A-110D. A processing element may include one or more stream operators fused together to form an independently running process with its own process ID (PID) and memory space. In cases where two (or more) processing elements are running independently, inter-process communication may occur using a “transport,” e.g., a network socket, a TCP/IP socket, or shared memory. Inter-process communication paths used for inter-process communications can be a critical resource in a stream computing application. However, when stream operators are fused together, the fused stream operators can use more rapid communication techniques for passing tuples among stream operators in each processing element.

The operator graph 500 begins at a source 135 and ends at a sink 504, 506. Compute node 110A includes the processing elements PE1, PE2, and PE3. Source 135 flows into the processing element PE1, which in turn outputs tuples that are received by PE2 and PE3. For example, PE1 may split data attributes received in a tuple and pass some data attributes in a new tuple to PE2, while passing other data attributes in another new tuple to PE3. As a second example, PE1 may pass some received tuples to PE2 while passing other tuples to PE3. Tuples that flow to PE2 are processed by the stream operators contained in PE2, and the resulting tuples are then output to PE4 on compute node 110B. Likewise, the tuples output by PE4 flow to PE6 and to operator sink 504. Similarly, tuples flowing from PE3 to PE5 and to PE6 also reach the operators in sink 504. Thus, in addition to being a sink for this example operator graph, PE6 could be configured to perform a join operation, combining tuples received from PE4 and PE5. This example operator graph also shows tuples flowing from PE3 to PE7 on compute node 110C, which itself shows tuples flowing to PE8 and looping back to PE7. Tuples output from PE8 flow to PE9 on compute node 110D, which in turn outputs tuples to be processed by operators in a sink processing element, for example PE10 506.

Processing elements 235 (FIG. 2) may be configured to receive or output tuples in various formats, e.g., the processing elements or stream operators could exchange data marked up as XML, documents. Furthermore, each stream operator 240 within a processing element 235 may be configured to carry out any form of data processing functions on received tuples, including, for example, writing to database tables or performing other database operations such as data joins, splits, reads, etc., as well as performing other data analytic functions or operations.

The stream manager 134 of FIG. 1 may be configured to monitor a stream computing application running on compute nodes, e.g., compute nodes 110A-110D, as well as to change the deployment of an operator graph, e.g., operator graph 132. The stream manager 134 may move processing elements from one compute node 110 to another, for example, to manage the processing loads of the compute nodes 110A-110D in the computing infrastructure 100. Further, stream manager 134 may control the stream computing application by inserting, removing, fusing, un-fusing, or otherwise modifying the processing elements and stream operators (or what tuples flow to the processing elements) running on the compute nodes 110A-110D.

Because a processing element may be a collection of fused stream operators, it is equally correct to describe the operator graph as one or more execution paths between specific stream operators, which may include execution paths to different stream operators within the same processing element. FIG. 5 illustrates execution paths between processing elements for the sake of clarity.

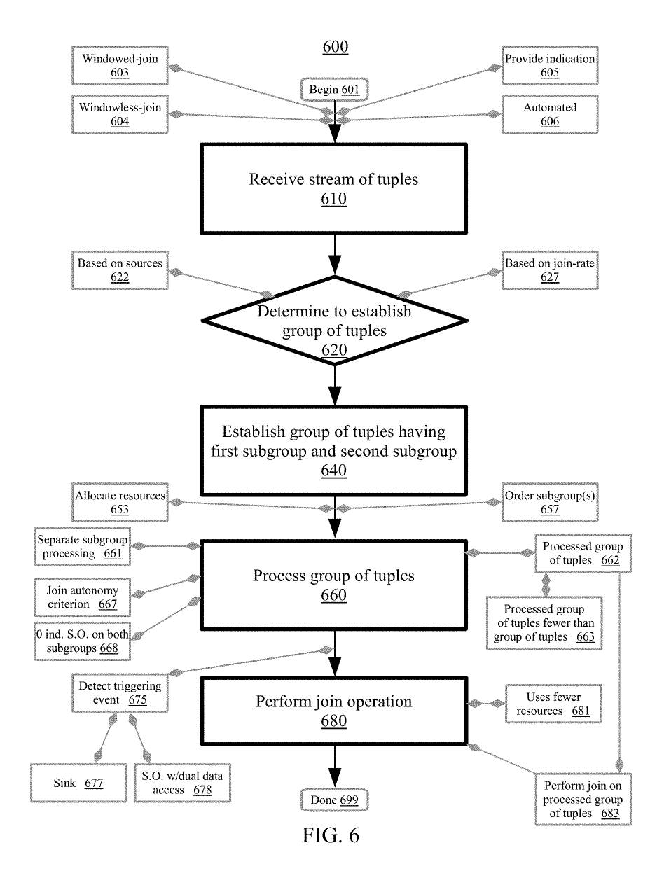

FIG. 6 is a flowchart illustrating a method 600 for deferred joining of a stream of tuples according to embodiments. Method 600 may begin at block 601. In embodiments, the deferred joining of the stream of tuples occurs in a windowed-join environment (e.g., an environment having a bound such as a temporal period which overlaps between a plurality of segments of the stream of tuples) at block 603. In certain embodiments, the deferred joining of the stream of tuples occurs in a windowless-join environment (e.g., an environment without a rigid bound that requires overlapping time-based segments of data) at block 604.

In embodiments, an indication of the deferred joining can be provided, presented, sent, or displayed (e.g., to a user) at block 605. Accordingly, the indication may utilized to develop a streaming application in an integrated development environment. For example, a streaming application may be more efficiently developed when a developer/user is notified of the deferred join so that the developer/user can further program the streaming application to take advantage of the performance or efficiency benefits (e.g., inserting certain filter or sort operations before the actual join instead of after). Various types of user logic could be used including, for instance, format conversion (e.g., converting a data from “MM/DD/YYYY” format to “Month Day, Year” format). Accordingly, many different operators and logic not explicitly listed herein may be utilized in conjunction with disclosed aspects. In embodiments, the operational steps (e.g., the receiving, the determining, the establishing, the processing, the performing) each occur in an automated fashion without user intervention at block 606. As such, the developer/user may not be informed of the deferred join without the notification mentioned previously, and subsequent programming may occur consistent with use of the deferred join.

At block 610, the stream of tuples which is to be processed by a plurality of stream operators is received (e.g., detected, sensed, accepted as an input). The plurality of stream operators may include processing threads configured to perform operations (e.g., analysis logic, attribute modification) on data (e.g., tuples) as part of a stream computing application. The stream of tuples may include both a first set of tuples from a first source and a second set of tuples from a second source. Such sets of tuples may be mapped, correlated, tagged, or otherwise tracked with respect to their respective source. For example, the first set of tuples having a first quantity of tuples (e.g., 100) may be received from the first source (e.g., source X) and the second set of tuples having a second quantity of tuples (e.g., 100) may be received from the second source (e.g., source Y). To illustrate, individual tuples may be designated as tuples X1, X2, X3, Y1, Y2, Y3, etc.

At block 620, a determination (e.g., computation, evaluation) is made to establish (e.g., form, construct, organize) a group of tuples. The group of tuples may include (all) tuples received collectively from the (first and second) sources. The determination is made for future utilization with respect to a join operation. The (future) join operation indicates to (later) join the first and second sets of tuples. In embodiments, the join operation may correlate tuples from separate sources based on user-specified match predicates and window configurations. For example, when a tuple is received on an input port (e.g., for the first source), it is inserted into the window corresponding to the input port, which causes the window to trigger. As part of the trigger processing, the tuple can be compared against tuples inside the window of the opposing input port (e.g., for the second source). If a tuple match is ascertained, then an output tuple may be produced in the future for each tuple match (along with a window punctuation after the outputs). To illustrate, the future output tuples may include (X1, Y1), (X2, Y1), (X3, Y1), . . . , (X50, Y50), . . . , etc.

Tuples may be grouped in a variety of ways, methodologies, processes, or operations. In embodiments, determining to establish the group of tuples includes determining to establish the group of tuples based on the first and second sources at block 622. Accordingly, a first subgroup (of the group of tuples) includes the first set of tuples and a second subgroup (of the group of tuples) includes the second set of tuples. As such, a distinction may be maintained within the group of tuples as to the source of individual tuples (e.g., grouping all tuples from source X in an X subgroup and grouping all tuples from source Y in a Y subgroup). Such subgroups may be tagged, labeled, or marked as such for utilization in processing or performance of operations.

In embodiments, determining to establish the group of tuples includes determining to establish the group of tuples based on an expected join-rate at block 627. The expected join-rate can include a predicted throughput of actual join operation performance/execution (e.g., based on data in the tuples). For example, more tuples with more data can have a slower or comparatively challenged throughput with respect to fewer tuples with a lesser quantity of data. As such, the first subgroup (of the group of tuples) includes both a first portion of the first set of tuples and a first portion of the second set of tuples, and the second subgroup (of the group of tuples) includes both a second portion of the first set of tuples and a second portion of the second set of tuples. Using the expected join-rate, performance or efficiency benefits such as resource usage or load balancing may occur. To illustrate, the first subgroup could have twice as many tuples as the second subgroup and the joins of the first subgroup are expected to take half the time of the second subgroup. Other ways, methodologies, processes, or operations of grouping tuples are considered.

At block 640, a first stream operator of the plurality of stream operators establishes the group of tuples. Establishing can include forming, constructing, organizing, classifying, categorizing, generating, or creating. The group of tuples may include (all) tuples received collectively from the (first and second) sources. The group of tuples may have both a first subgroup and a second subgroup. In various embodiments, tuples of the subgroups may be part of only one subgroup. For example, tuples organized by source may only be part of the particular subgroup associated with the particular source of the particular tuple. The group of tuples may be established as a data structure to be used in subsequent processing or operation performance. Other possibilities for establishing the group of tuples are considered.

In embodiments, a set of computing resources may be allocated to the first and second subgroups at block 653. The allocation of the set of computing resources can be based on an expected join-rate. The expected join-rate can include a predicted throughput of actual join operation performance/execution (e.g., based on data in the tuples). Accordingly, more computing resources may be allocated to the subgroup which is predicted to take a longer amount of time. For example, the set of computing resources can include virtual machine computing capabilities or physical hardware allotments. As such, the set of computing resources may have processor resources (e.g., a quantity of processors, a speed/capability of processors), memory resources (e.g., an amount of volatile memory assigned), disk resources (e.g., an allotment of storage space), or bandwidth resources (e.g., how much data can be moved in a given temporal period).

In embodiments, at least one of the first subgroup or the second subgroup is ordered based on a sort criterion at block 657. The sort criterion may be based on priority of data in a tuple. For example, tuples originally sorted by arrival time may be reordered to be sorted based on transaction value (e.g., monetary/dollar value). As another example, tuples may be ordered based on an attribute such as tuple size, metadata, etc. The first and second subgroups may be ordered by different particular sort criteria (e.g., the first subgroup ordered by transaction value and the second subgroup sorted by tuple size and then arrival time). Other possibilities for ordering the subgroups are considered.

At block 660, a set of stream operators of the plurality of stream operators processes the group of tuples. Processing can include performing, carrying-out, initiating, launching, instantiating, implementing, enacting, running, executing one or more operations, jobs, or tasks on one or more tuples. The processing may occur in response to establishing the group of tuples, or in response to determining to perform a (future) join operation but prior to performing the (actual) join operation. Accordingly, the processing the processing on the group of tuples may provide overall performance or efficiency benefits with respect to more resource-intensive operations such as a join operation by reducing the overall burden on the streaming application as discussed herein. The set of stream operators may be related or unrelated, and may perform a variety of operations.

In embodiments, processing the group of tuples (by the set of stream operators of the plurality of stream operators) includes processing the first subgroup separate from the second subgroup, and processing the second subgroup separate from the first subgroup at block 661. For example, carrying-out a filter operation (to removes tuples from a stream by passing along only those tuples that satisfy a user-specified condition) on the group of tuples by a filter operator may include performing the filter operation on the first subgroup (e.g., filtering-out X3) separate from performing the filter operation on the second subgroup (e.g., filtering-out Y2). In certain embodiments, such filtering may be executed in parallel or in series. As another example, a sort operator may be used to order the group of tuples based on user-specified ordering expressions and window configurations by running the sort operator separately on the first and second subgroups. Separate subgroup processing at block 661 can save resources such as processing or memory by performing such example operations pre join as compared with post-join due to factors such as total number of tuples, tuple size, or the like.

In embodiments, processing the group of tuples (by the set of stream operators of the plurality of stream operators) includes processing the group of tuples to establish a processed group of tuples at block 662. The processed group of tuples may have both a first subset of the first set of tuples and a second subset of the second set of tuples. In various embodiments, the processed group of tuples includes fewer tuples than the group of tuples at block 663. For instance, the first subset may include tuples of the first set which were not filtered-out by the filter operator (while not including tuples of the first set which were filtered-out). In certain embodiments, a nature of the first subset may be different from a nature of the first set. For example, the first set and the first subset may include the same tuples in a different order (e.g., due to a sort operator). As such the processed group of tuples may be a subset of the group of tuples in a different form. Various operators and operations are considered to generate the processed group of tuples including custom operators or the like.

In embodiments, the set of stream operators meet a threshold join autonomy criterion at block 667. The threshold join autonomy criterion indicates that such operators process tuples in a manner that is independent as compared with running the join beforehand (e.g., will yield a valid results-set which may be identical as running the join beforehand). For instance, carrying-out the operations described in blocks 610, 620, 640, 660, 680 makes no substantive (e.g., minor difference such as a third-order-sort based on arrival time which does not change the contents or future usage) or actual difference (e.g., identical) with performing the join and then doing the processing. A threshold may be configured within the threshold join autonomy criterion to determine tolerance (e.g., a level of autonomy) with respect to how substantive the differences may be (e.g., the threshold may be configured to require an identity relationship in all aspects including order, the threshold may be configured to require the number of tuples to be the same, the threshold may be configured to require the size of tuples to map but can be in any order).

In various embodiments, the set of stream operators have zero individual stream operators which operates on both the first and second subgroups at block 668. For example, the group of tuples may transition through four stream operators which make-up the set of stream operators. The first and third of these particular stream operators may operate on only the first subgroup (e.g., only tuples from source X), and the second and fourth of these particular stream operators may operate on only the second subgroup (e.g., only tuples from source Y). Such operations may be performed in series or in parallel. Performance or efficiency benefits may result due to lesser overall computing resource usage (as compared to performing the join and then operating on all of the joined tuples) by a factor (e.g., in the example where the tuples are equivalent in size and quantity the computing resource usage saved may be a factor of two when the operations utilize equivalent computing resources).

In embodiments, a triggering event is detected at block 675. The triggering event may anticipate (e.g., expect, prepare for) performance of the join operation. The triggering event may include a sink at block 677. The sink may write tuples. The triggering event including the sink can include detecting a sink operator within a threshold number of operators or expecting to reach a sink operator within a threshold temporal period. For example, as tuples are being processed, the streaming application may monitor for or detect presence of a sink operator. When the group of tuples gets sufficiently close (e.g., the sink is next, the sink is 3 operators away, the sink is within 10% of the total number of operators away), the join operation may be scheduled or performed. The triggering event may include a second stream operator which accesses data of both the first and second subgroups at block 678. For instance, the join operation may be desired to be performed before the second stream operator processes the group of tuples. For performance or efficiency benefits, when both the first and second subgroups are to have data accessed, having the join operation being performed may reduce computing resource usage relative to not performing the join operation (e.g., data access requests can be resource intensive). Analysis can be performed comparing possible configurations with respect to when to perform the join operation based on aspects described herein (to positively impact computing resource usage).

At block 680, the join operation is performed in response to processing the group of tuples. Such performance can include the actual running of the join operation (e.g., beyond determining to execute the join operation). In embodiments, performing the join operation in response to processing the group of tuples uses fewer computing resources than processing the group of tuples in response to performing the join operation at block 681. A comparison of such differently ordered steps may be made using actual or forecast data to show the reduction in computing resource usage (e.g., lesser processing power may be needed since tuples were filtered-out pre-join that otherwise would have used such processing power had the join operation been performed before the filter operation due to the resource-intensive nature of join operations as compared to other operations such as filter operations). Computer resource usage may be calculated in terms of processor usage (including time-in-use of processing resources), memory usage (including time-in-use of memory resources), or disk usage. In certain embodiments, performing the join operation includes carrying-out the join operation on the processed group of tuples at block 683. Accordingly, the (actual) join operation may be performed on fewer tuples (e.g., the processed group rather than the group as a whole). For example, when specific tuples X3 and Y2 are filtered-out, the resultant joins do not include possible combinations with those specific tuples. As such, joined tuples can include (X1, Y1), (X1, Y3), (X2, Y1), (X2, Y3), etc. without including (X1, Y2), (X2, Y2), (X3, Y1), (X3, Y2), (X3, Y3), etc.

Method 600 concludes at block 699. Aspects of method 600 may provide performance or efficiency benefits for deferred joining of a stream of tuples (e.g., by reducing the number of actual joins). For example, aspects of method 600 may have positive impacts with respect to development of a streaming application such as speeding-up tuple processing while also not delaying individual tuples. Altogether, deferred joining may be associated with performance or efficiency benefits for joining the stream of tuples (e.g., resource usage, load balancing, productivity, speed-up tuple processing).

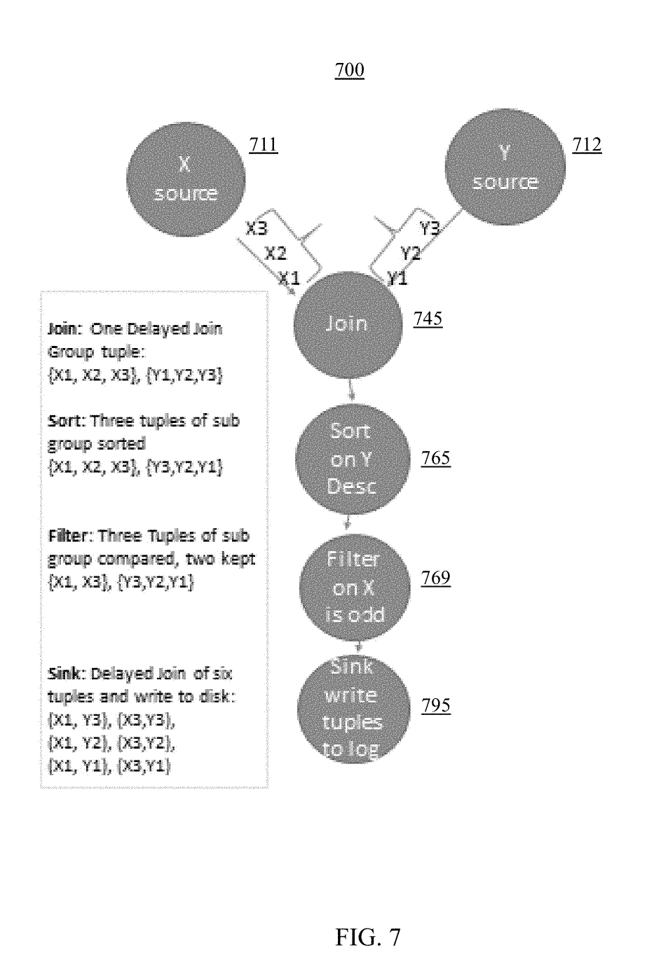

FIG. 7 is an example operator graph 700 of a deferred join when joining a set of windows according to embodiments. Sources 711 and 712 feed into a deferred/delayed join operator 745 which determines to defer/delay the join operation using a group having subgroups as described herein. At example sort operator 765, the subgroups are sorted separately as described herein. At example filter operator 769, the subgroups are filtered separately as described herein. At sink 795, the deferred/delayed join is performed (e.g., in advance of writing the tuples to disk).

Aspects of the disclosure may save a group of tuples to be joined in their respective subgroups based on which source stream they came from. The group size can be based on a window. The ordering within groups or subgroups may be based on the order in which the tuples come in (e.g., arrival time) so that the order can be replayed in the deferred join if appropriate/needed. In certain embodiments, timestamps of different tuples in the group could be saved for more precision. If a join is eventually needed, the join proceeds by joining each tuple in each subgroup to every other tuple in every other subgroup. Multiple groups/subgroups are supported to support multiple joins and join types. If there is additional join selection, it can be applied at the (actual) join processing. In embodiments, it can be applied at the deferred join determination.

Accordingly, the received tuples proceed downstream in the deferred join format and are processed in that deferred join format by subsequent operators as in FIG. 7. In certain embodiments, such processing can include one or more other join operators. The actual join operation may be deferred/delayed (indefinitely) until an operator is encountered which is appropriate for (e.g., absolutely needs) the real joined tuples (e.g., the sink 795). Then, the deferred join may executed as an actual/real join producing real tuples.

In embodiments, a streams runtime may reorder groups or form subgroups. For example, the subgroups can be sorted based on a priority of data in a tuple (e.g., monetary value), or an attribute of a tuple such as size, or another criteria. Subgroups may be formed based on specific qualifications, such as the rate of performing the actual join of tuples. For example, one subgroup could be created to have 20 tuples where the join takes less time but another subgroup to be joined could have 10 tuples where the join takes longer (based on the data in the tuple). In the latter case, both subgroups may finish at the same time (e.g., within a sameness threshold of 5% of the overall processing time). In a different example, more resources could be allocated (e.g., memory capability or processing power in a cloud environment) to a subgroup to be joined that historical data indicates to take longer to be joined so that it will finish at the same time with other subgroups. Also, the groups/subgroups may have metadata associated with them such as timestamps of the begin/end of the window, average of tuples priority, or join statistics such as cardinality and estimated number of tuples of the complete actual/real join. In embodiments, the streams runtime takes care of the deferred join automatically; as such, a streams developer and users may be unaware of it, and program as normal (except in embodiments where an indication is provided). In other embodiments, the developer can see the delayed join (in an integrated development environment) semantics/schema/tuples and write operators directly related to aspects described herein.

In addition to embodiments described above, other embodiments having fewer operational steps, more operational steps, or different operational steps are contemplated. Also, some embodiments may perform some or all of the above operational steps in a different order. In embodiments, operational steps may be performed in response to other operational steps. The modules are listed and described illustratively according to an embodiment and are not meant to indicate necessity of a particular module or exclusivity of other potential modules (or functions/purposes as applied to a specific module).

In the foregoing, reference is made to various embodiments. It should be understood, however, that this disclosure is not limited to the specifically described embodiments. Instead, any combination of the described features and elements, whether related to different embodiments or not, is contemplated to implement and practice this disclosure. Many modifications and variations may be apparent to those of ordinary skill in the art without departing from the scope and spirit of the described embodiments. Furthermore, although embodiments of this disclosure may achieve advantages over other possible solutions or over the prior art, whether or not a particular advantage is achieved by a given embodiment is not limiting of this disclosure. Thus, the described aspects, features, embodiments, and advantages are merely illustrative and are not considered elements or limitations of the appended claims except where explicitly recited in a claim(s).

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

Embodiments according to this disclosure may be provided to end-users through a cloud-computing infrastructure. Cloud computing generally refers to the provision of scalable computing resources as a service over a network. More formally, cloud computing may be defined as a computing capability that provides an abstraction between the computing resource and its underlying technical architecture (e.g., servers, storage, networks), enabling convenient, on-demand network access to a shared pool of configurable computing resources that can be rapidly provisioned and released with minimal management effort or service provider interaction. Thus, cloud computing allows a user to access virtual computing resources (e.g., storage, data, applications, and even complete virtualized computing systems) in “the cloud,” without regard for the underlying physical systems (or locations of those systems) used to provide the computing resources.

Typically, cloud-computing resources are provided to a user on a pay-per-use basis, where users are charged only for the computing resources actually used (e.g., an amount of storage space used by a user or a number of virtualized systems instantiated by the user). A user can access any of the resources that reside in the cloud at any time, and from anywhere across the Internet. In context of the present disclosure, a user may access applications or related data available in the cloud. For example, the nodes used to create a stream computing application may be virtual machines hosted by a cloud service provider. Doing so allows a user to access this information from any computing system attached to a network connected to the cloud (e.g., the Internet).

Embodiments of the present disclosure may also be delivered as part of a service engagement with a client corporation, nonprofit organization, government entity, internal organizational structure, or the like. These embodiments may include configuring a computer system to perform, and deploying software, hardware, and web services that implement, some or all of the methods described herein. These embodiments may also include analyzing the client's operations, creating recommendations responsive to the analysis, building systems that implement portions of the recommendations, integrating the systems into existing processes and infrastructure, metering use of the systems, allocating expenses to users of the systems, and billing for use of the systems.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing is directed to exemplary embodiments, other and further embodiments of the invention may be devised without departing from the basic scope thereof, and the scope thereof is determined by the claims that follow. The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

What is claimed is:

1. A computer-implemented method for deferred joining of a stream of tuples, the method comprising:
receiving the stream of tuples to be processed by a plurality of stream operators, wherein the stream of tuples includes both a first set of tuples from a first source and a second set of tuples from a second source;
determining, for future utilization with respect to a join operation which indicates to join the first and second sets of tuples, to establish a group of tuples;
establishing, by a first stream operator of the plurality of stream operators, the group of tuples having both a first subgroup and a second subgroup;
processing, by a set of stream operators of the plurality of stream operators, the group of tuples; and
performing, in response to processing the group of tuples, the join operation.

2. The method of claim 1, wherein processing, by the set of stream operators of the plurality of stream operators, the group of tuples includes:
processing the first subgroup separate from the second subgroup; and
processing the second subgroup separate from the first subgroup.

3. The method of claim 1, wherein processing, by the set of stream operators of the plurality of stream operators, the group of tuples includes:
processing the group of tuples to establish a processed group of tuples having both a first subset of the first set of tuples and a second subset of the second set of tuples.

4. The method of claim 3, wherein the processed group of tuples includes fewer tuples than the group of tuples.

5. The method of claim 3, wherein performing the join operation includes:
performing the join operation on the processed group of tuples.

6. The method of claim 1, wherein performing the join operation in response to processing the group of tuples uses fewer computing resources than processing the group of tuples in response to performing the join operation.

7. The method of claim 1, further comprising detecting a triggering event, wherein performing the join operation occurs in response to detecting the triggering event.

8. The method of claim 7, wherein detecting the triggering event includes a selection from a group consisting of at least one of: a sink, or a second stream operator which accesses data of both the first and second subgroups.

9. The method of claim 1, wherein the set of stream operators meet a threshold join autonomy criterion.

10. The method of claim 1, wherein the set of stream operators have zero individual stream operators which operates on both the first and second subgroups.

11. The method of claim 1, wherein:
determining to establish the group of tuples includes determining to establish the group of tuples based on the first and second sources;
the first subgroup includes the first set of tuples; and
the second subgroup includes the second set of tuples.

12. The method of claim 1, wherein:
determining to establish the group of tuples includes determining to establish the group of tuples based on an expected join-rate;
the first subgroup includes a first portion of the first set of tuples and a first portion of the second set of tuples; and
the second subgroup includes a second portion of the first set of tuples and a second portion of the second set of tuples.

13. The method of claim 1, further comprising:
allocating, based on an expected join-rate, a set of computing resources to the first and second subgroups.

14. The method of claim 1, further comprising:
ordering, based on a sort criterion, at least one of the first subgroup or the second subgroup.

15. The method of claim 1, wherein the deferred joining of the stream of tuples occurs in at least one of: a windowed-join environment, or a windowless-join environment.

16. The method of claim 1, further comprising:
providing, for utilization to develop a streaming application in an integrated development environment, an indication of the deferred joining.

17. The method of claim 1, wherein the receiving, the determining, the establishing, the processing, and the performing each occur in an automated fashion without user intervention.

18. A system for deferred joining of a stream of tuples, the system comprising:
a memory having a set of computer readable computer instructions, and
a processor for executing the set of computer readable instructions, the set of computer readable instructions including:
receiving the stream of tuples to be processed by a plurality of stream operators, wherein the stream of tuples includes both a first set of tuples from a first source and a second set of tuples from a second source;
determining, for future utilization with respect to a join operation which indicates to join the first and second sets of tuples, to establish a group of tuples;
establishing, by a first stream operator of the plurality of stream operators, the group of tuples having both a first subgroup and a second subgroup;
processing, by a set of stream operators of the plurality of stream operators, the group of tuples; and
performing, in response to processing the group of tuples, the join operation.

19. A computer program product for deferred joining of a stream of tuples, the computer program product comprising a computer readable storage medium having program instructions embodied therewith, wherein the computer readable storage medium is not a transitory signal per se, the program instructions executable by a processor to cause the processor to perform a method comprising:
receiving the stream of tuples to be processed by a plurality of stream operators, wherein the stream of tuples includes both a first set of tuples from a first source and a second set of tuples from a second source;
determining, for future utilization with respect to a join operation which indicates to join the first and second sets of tuples, to establish a group of tuples;
establishing, by a first stream operator of the plurality of stream operators, the group of tuples having both a first subgroup and a second subgroup;
processing, by a set of stream operators of the plurality of stream operators, the group of tuples; and
performing, in response to processing the group of tuples, the join operation.

20. The computer program product of claim 19, wherein at least one of:
the program instructions are stored in a computer readable storage medium in a data processing system, and wherein the program instructions were downloaded over a network from a remote data processing system; or
the program instructions are stored in a computer readable storage medium in a server data processing system, and wherein the program instructions are downloaded over a network to a remote data processing system for use in a computer readable storage medium with the remote data processing system.
